(19) United States
(12) Patent Application Publication
(10) Pub. No.: US 2022/0154820 A1
(43) Pub. Date: May 19, 2022

(54) SHIFT RANGE CONTROL DEVICE

(71) Applicant: DENSO CORPORATION, Kariya-city (JP)

(72) Inventors: Haruka Miyano, Kariya-city (JP); Kouji Sakaguchi, Kariya-city (JP); Jun Yamada, Kariya-city (JP); Seiji Nakayama, Kariya-city (JP)

(21) Appl. No.: 17/592,133

(22) Filed: Feb. 3, 2022

Related U.S. Application Data
(63) Continuation of application No. PCT/JP2020/031162, filed on Aug. 18, 2020.

(30) Foreign Application Priority Data
Aug. 26, 2019 (JP) 2019-153695

(51) Int. Cl. F16H 61/12; F16H 61/32; F16H 63/34; G07C 5/08

(52) U.S. Cl. CPC F16H 61/12; F16H 61/32; F16H 63/34; F16H 63/38; F16H 2061/1256; F16H 2061/326; G07C 5/0816

(57) ABSTRACT

A shift range control device controls a shift range switching system including an actuator, an output shaft, and a shift range switching mechanism. The shift range control device includes a target setting unit, a drive control unit, and an abnormality monitoring unit. The target setting unit sets a target shift range. The drive control unit controls the drive of the actuator so that the engagement member fits into the target valley portion, which is the valley portion corresponding to the target shift range. The abnormality monitoring unit monitors an abnormality. When a stagnation abnormality is determined in which the engagement member does not reach the target valley portion and stagnates, the drive control unit controls the drive of the actuator so that the engagement member fits into the valley portion on the side where the engagement member is returned from a stagnant position.

### CROSS REFERENCE TO RELATED APPLICATIONS

This application is a continuation application of International Patent Application No. PCT/JP2020/031162 filed on Aug. 18, 2020, which designated the U.S. and based on and claims the benefits of priority of Japanese Patent Application No. 2019-153695 filed on Aug. 26, 2019, The entire disclosure of all of the above applications is incorporated herein by reference.

### TECHNICAL FIELD

The present disclosure relates to a shift range control device.

### BACKGROUND

There has hitherto known a shift range switch device that switches a shift range by controlling a motor.

### SUMMARY

An object of the present disclosure is to provide a shift range control device that appropriately controls an engaging position of an engagement member.

The shift range control device of the present disclosure controls a shift range switching system. The shift range switching system includes an actuator, an output shaft driven by the actuator, and a shift range switching mechanism. The shift range switching mechanism includes a driven member, an engagement member, and an urging member. The driven member has a plurality of valley potions and peak portions separating the valley portions, and rotates together with the output shaft. The engagement member can move in the valley portion by driving the actuator. The urging member urges the engagement member in a direction to fit in the valley portion.

The shift range control device includes a target setting unit, a drive control unit, and an abnormality monitoring unit. The target setting unit sets a target shift range. The drive control unit controls the drive of the actuator so that the engagement member fits into the target valley portion, which is the valley portion corresponding to the target shift range. The abnormality monitoring unit monitors an abnormality.

### BRIEF DESCRIPTION OF DRAWINGS

The above and other objects, features and advantages of the present disclosure will become more apparent from the following detailed description made with reference to the accompanying drawings. In the drawings:

FIG. 1 is a perspective view showing a shift-by-wire system according to one embodiment;

FIG. 2 is a block diagram showing a general configuration of the shift-by-wire system according to the one embodiment;

FIG. 3 is a circuit diagram showing a motor winding and a drive circuit according to the one embodiment;

FIG. 4 is a flowchart illustrating a drive mode selection process according to the one embodiment;

FIG. 5 is a flowchart illustrating a drive mode elapsed time calculation process according to the one embodiment;

FIG. 6 is a flowchart illustrating a stagnation detection process according to the one embodiment;

FIG. 7 is a flowchart illustrating a low voltage and low current determination process according to the one embodiment;

FIG. 8 is a flowchart illustrating a target range resetting process according to the one embodiment;

FIG. 9 is a schematic diagram illustrating a range switching process when torque is insufficient according to the one embodiment;

FIG. 10 is a time chart illustrating a range switching process when torque is insufficient according to the one embodiment;

FIG. 11 is a schematic diagram illustrating a range switching process when torque is insufficient according to the one embodiment;

FIG. 12 is a time chart illustrating a range switching process when torque is insufficient according to the one embodiment;

FIG. 13 is a schematic diagram illustrating a range switching process when torque is insufficient according to the one embodiment;

FIG. 14 is a time chart illustrating a range switching process when torque is insufficient according to the one embodiment;

FIG. 15 is a schematic diagram illustrating a range switching process at the time of mechanical lock according to the one embodiment;

FIG. 16 is a time chart illustrating a range switching process at the time of mechanical lock according to the one embodiment;

FIG. 17 is a schematic diagram illustrating a range switching process at the time of mechanical lock according to the one embodiment;

FIG. 18 is a time chart illustrating a range switching process at the time of mechanical lock according to the one embodiment;

FIG. 19 is a schematic view illustrating a range switching process at the time of mechanical lock according to the one embodiment; and

FIG. 20 is a time chart illustrating a range switching process at the time of mechanical lock according to the one embodiment.

### DETAILED DESCRIPTION

In an assumable example, a shift range switch device switches a shift range by controlling a motor. Control of a motor to locate a detent roller before a center of a target valley portion in a driving direction enables to fit the detent roller onto a center of the target valley portion, even when the motor stops at any position within a control error range.

However, even if the control is performed, if an abnormality such as a low voltage abnormality or a mechanical lock occurs, the detent roller may stop at an intermediate position and a manual valve may not be controlled to an appropriate position. An object of the present disclosure is to provide a shift range control device that appropriately controls an engaging position of an engagement member.

The shift range control device of the present disclosure controls a shift range switching system. The shift range switching system includes an actuator, an output shaft driven by the actuator, and a shift range switching mechanism. The shift range switching mechanism includes a driven member, an engagement member, and an urging member. The driven member has a plurality of valley potions and peak portions separating the valley portions, and rotates together with the output shaft. The engagement member can move in the valley portion by driving the actuator. The urging member urges the engagement member in a direction to fit in the valley portion.

The shift range control device includes a target setting unit, a drive control unit, and an abnormality monitoring unit. The target setting unit sets a target shift range. The drive control unit controls the drive of the actuator so that the engagement member fits into the target valley portion, which is the valley portion corresponding to the target shift range. The abnormality monitoring unit monitors an abnormality.

When a stagnation abnormality is determined in which the engagement member does not reach the target valley portion and stagnates, the drive control unit controls the drive of the actuator so that the engagement member fits into the valley portion on the side where the engagement member is returned from a stagnant position. As a result, even when the stagnation abnormality occurs, the engagement member can be appropriately fitted into any of the valley portions.

### One Embodiment

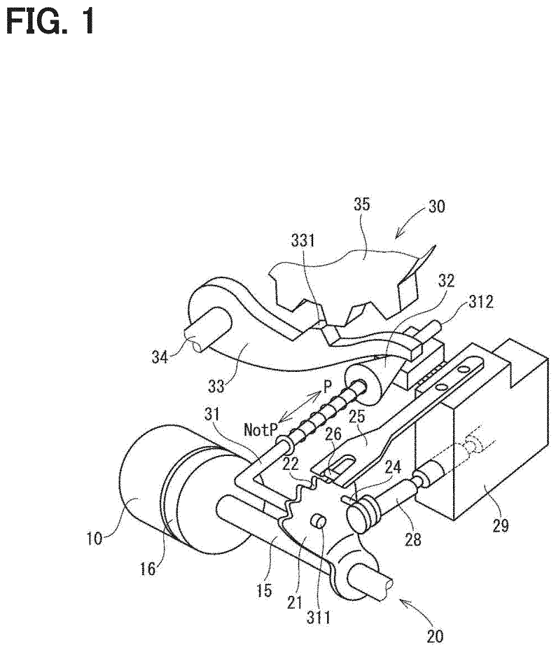

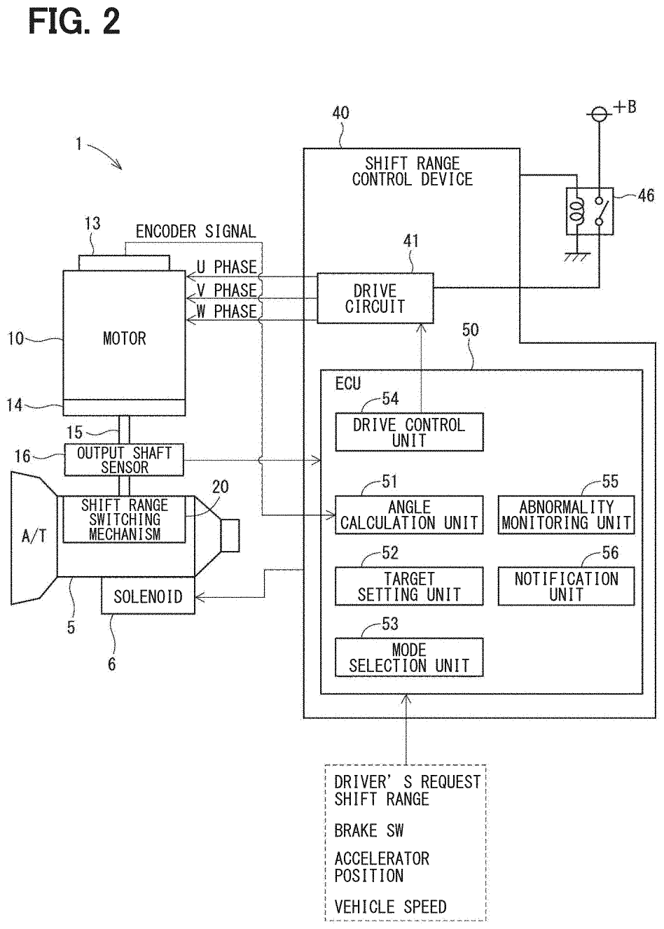

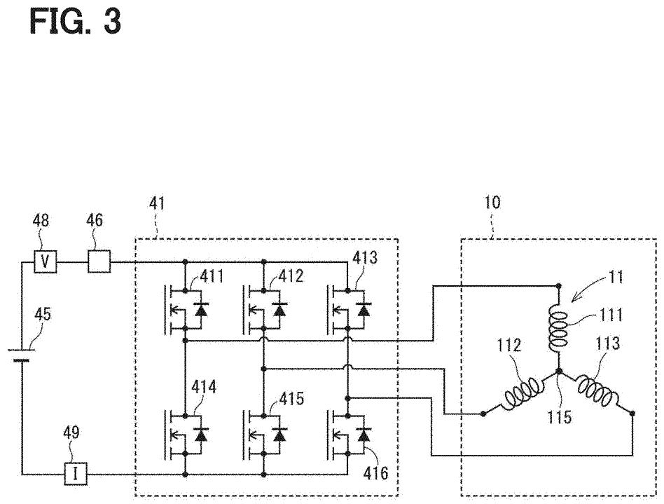

Hereinafter, a shift range control device according to the present disclosure will be described with reference to the drawings. A shift range control device according to one embodiment is shown in FIGS. 1 to 20. As shown in FIGS. 1 and 2, a shift-by-wire system 1 includes, for example, a motor 10, a shift range switching mechanism 20, a parking lock mechanism 30, and a shift range control device 40, and the like. The motor 10 rotates when an electric power is supplied from a battery 45 (refer to FIG. 3) mounted on a vehicle (not shown), and functions as a driving source of the shift range switching mechanism 20. The motor 10 according to the present embodiment is a DC brushless motor, but may be a switched reluctance motor or the like. As shown in FIG. 3, the motor 10 has a motor winding 11 wound around a stator (not shown). The motor winding 11 has a U-phase coil 111, a V-phase coil 112, and a W-phase coil 113.

As shown in FIG. 2, an encoder 13, which is a rotation angle sensor, detects a rotation position of a rotor (not shown) of the motor 10. The encoder 13 is, for example, a magnetic rotary encoder and is made up of a magnet that rotates integrally with the rotor, a magnetic detection hall integrated circuit (IC), and the like. The encoder 13 outputs an encoder signal, which is a three-phase pulse signal, at predetermined angles in synchronization with the rotation of the rotor.

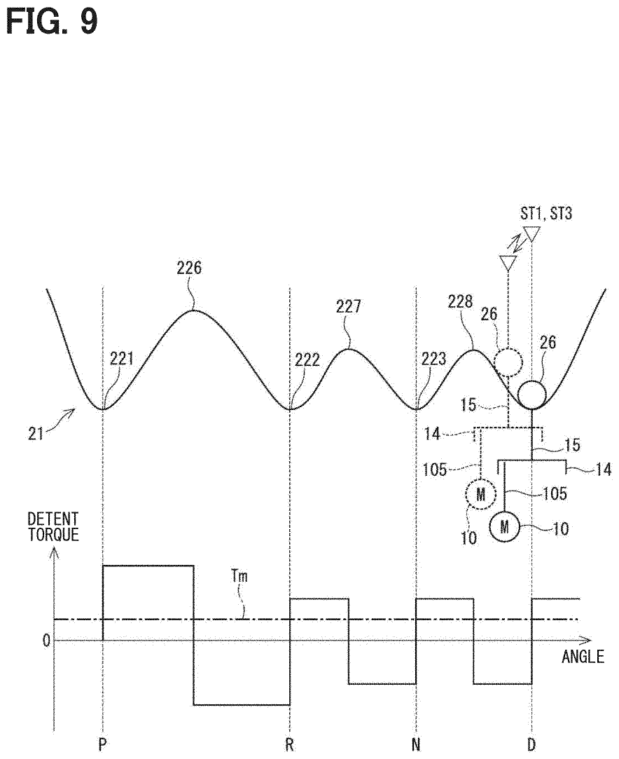

A speed reducer 14 is provided between a motor shaft 105 (refer to FIG. 9 and the like) of the motor 10 and an output shaft 15, decelerates the rotation of the motor 10, and outputs the rotation to the output shaft 15. The rotation of the motor 10 is thus transmitted to the shift range switching mechanism 20. An output shaft sensor 16 for detecting an angle of the output shaft 15 is provided on the output shaft 15. The output shaft sensor 16 is, for example, a potentiometer. Hereinafter, a rotation position of the output shaft 15 based on a detection value of the output shaft sensor 16 is defined as an output shaft angle θs.

As shown in FIG. 1, the shift range switching mechanism 20 has a detent plate 21, a detent spring 25, a detent roller 26, and the like, and transmits a rotational driving force output from the speed reducer 14 to a manual valve 28 and a parking lock mechanism 30.

The detent plate 21 is fixed to the output shaft 15 and driven by the motor 10. According to the embodiment, the direction in which the detent plate 21 moves away from the proximal end of the detent spring 25 is referred to as a forward rotation direction, and the direction in which the detent plate approaches the proximal end is referred to as a reverse rotation direction.

The detent plate 21 has a pin 24 protruding in parallel with the output shaft 15. The pin 24 is connected to the manual valve 28. The detent plate 21 is driven by the motor 10, whereby the manual valve 28 reciprocates in an axial direction. That is, the shift range switching mechanism 20 converts the rotational motion of the motor 10 into a linear motion and transmits the linear motion to the manual valve 28. The manual valve 28 is provided on a valve body 29. When the manual valve 28 moves back and forth in the axial direction to switch hydraulic pressure supply paths, which are lead to a hydraulic clutch (not shown), thereby to switch an engagement state of the hydraulic clutch. In this way, the shift range is switched.

As schematically shown in FIG. 9 and the like, four valley portions 221 to 224 are provided on a detent spring 25 side of the detent plate 21. The valley portions 221 to 224 correspond to the respective ranges of P (parking), R (reverse), N (neutral), and D (drive), Further, a mountain portion 226 is provided between the valley portion 221 corresponding to the P range and the valley portion 222 corresponding to the R range. A mountain portion 227 is provided between the valley portion 222 corresponding to the R range and the valley portion 223 corresponding to the N range. A mountain portion 228 is provided between the valley portion 223 corresponding to the N range and the valley portion 224 corresponding to the D range. Walls that regulate the movement of the detent roller 26 are formed at both ends of the valley portions 221 to 224 that are arranged. As a result, the detent roller 26 moves between the valley portion 221 and the valley portion 224 as the motor 10 is driven.

A play is formed between the motor shaft 105 and the output shaft 15. In FIG. 9 and the like, the speed reducer 14 and the output shaft 15 are integrated, and a “play” is formed between the motor shaft 105 and the speed reducer 14, but the motor shaft 105 and the speed reducer 14 may be integrated and a “play” may be formed between the speed reducer 14 and the output shaft 15. The “play” can be regarded as the total amount of plays provided between the motor shaft 105 and the output shaft 15.

As shown in FIG. 1, the detent spring 25 is a plate-shaped urging member that can be elastically deformed, and the detent roller 26 is provided at a tip thereof. The detent roller 26 fits into one of the valley portions 221 to 224. The detent spring 25 biases the detent roller 26 toward a rotation center of the detent plate 21. When a rotational force equal to or larger than a predetermined level is applied to the detent plate 21, the detent spring 25 is deformed resiliently to enable the detent roller 26 to move among the valley sections 221 to 224. The detent roller 26 fits into one of the valley portions 221 to 224 thereby to restrict movement of the detent plate 21. In this way, the axial position of the manual valve 28 and the state of the parking lock mechanism 30 are adjusted, and the shift range of an automatic transmission 5 is fixed.

The parking lock mechanism 30 includes a parking rod 31, a conical member 32, a parking lock pawl 33, a shaft part 34 and a parking gear 35. The parking rod 31 is formed in a substantially L-shape. The parking rod 31 is fixed to the detent plate 21 on a side of one end 311. The conical member 32 is provided to the other end 312 of the parking rod 31. The conical member 32 is formed to reduce in diameter toward the other end 312. When the detent plate 21 rotates in the direction in which the detent roller 26 fits into the valley portion corresponding to the P range, the conical member 32 moves in the direction of the arrow P.

The parking lock pole 33 comes into contact with a conical surface of the conical member 32 and is provided so as to be swingable around the shaft part 34. On the parking gear 35 side of the parking lock pole 33, a protrusion 331 that can mesh with the parking gear 35 is provided. When the conical member 32 moves in the direction of the arrow P due to the rotation of the detent plate 21, the parking lock pole 33 is pushed up and the protrusion 331 and the parking gear 35 mesh with each other. On the other hand, when the conical member 32 moves in the direction of the arrow NotP, the meshing between the protrusion 331 and the parking gear 35 is released.

The parking gear 35 is provided on an axle (not shown) and is enabled to mesh with the protrusion 331 of the parking lock pawl 33. When the parking clear 35 meshes with the protrusion 331, rotation of the axle is restricted, When the shift range is one of the ranges (Not P range) other than the P range, the parking gear 35 is not locked by the parking lock pawl 33. Therefore, the rotation of the axle 95 is not restricted by the parking lock mechanism 30. When the shift range is the P range, the parking gear 35 is locked by the parking lock pawl 33 and the rotation of the axle is restricted.

As shown in FIGS. 2 and 3, the shift range control device 40 includes a drive circuit 41, an ECU 50, and the like. As shown in FIG. 3, the drive circuit 41 is a three-phase inverter that switches the energization of the motor winding 11 and the switching elements 411 to 416 are bridge-connected. The switching elements 411 and 414 are paired and belong to U phase. The switching elements 411 and 414 have a connection point therebetween, and the connection point is connected with one end of an U phase coil 111. The switching elements 412 and 415 are paired and belong to V phase. The switching elements 412 and 415 have a connection point therebetween, and the connection point is connected with one end of a V phase coil 112. The switching elements 413 and 416 are paired and belong to W phase. The switching elements 413 and 416 have a connection point therebetween, and the connection point is connected with one end of a W phase coil 113. The other ends of the coils 111 to 113 are connected to each other at a connected portion 115.

A motor relay 46 is provided between the drive circuit 41 and the battery 45. When the motor relay 46 is turned on, power supply from the battery 45 to the motor 10 side is allowed, and when it is turned off, the power supply from the battery 45 to the motor 10 side is cut off. A voltage sensor 48 detects a battery voltage Vb, which is the voltage of the battery 45. In the present embodiment, the battery voltage Vb is used as an input voltage input to the drive circuit 41. However, when a booster circuit or the like is provided, the voltage after boosting may be used as the voltage input to the drive circuit 41. A current sensor 49 detects a motor current Im flowing through the motor 19. The detected values of the voltage sensor 48 and the current sensor 49 are output to the ECU 50. A detection method and an installation position of the voltage sensor 48 and the current sensor 49 may be performed at a location other than those illustrated in FIG. 3. In FIG. 2, the voltage sensor 48 and the current sensor 49 are not shown.

As shown in FIG. 2, ECU 50 is mainly composed of a microcomputer and the like, and internally includes, although not shown in the figure, a CPU, a ROM, a RAM, an I/O, a bus line for connecting these components, and the like. Each process executed by the ECU 50 may be software processing or may be hardware processing. The software processing may be implemented by causing a CPU to execute a program. The program may be stored beforehand in a material memory device such as a ROM, that is, in a readable non-transitory tangible storage medium. The hardware processing may be implemented by a special purpose electronic circuit.

The ECU 50 controls the switching of the shift range by controlling the drive of the motor 10 based on the driver's request shift range, a signal from a brake switch, a vehicle speed, and the like. The ECU 50 performs a control to drive a transmission hydraulic control solenoid 6 based on a vehicle speed, an accelerator position, a shift range requested by a driver, and the like. The transmission hydraulic control solenoid 6 is controlled to manipulate a shift stage. The number of the transmission hydraulic control solenoids 6 is determined according to the shift stage or the like. According to the present embodiment, a singular ECU 50 performs the control to drive the motor 10 and the transmission hydraulic control solenoid 6. It is noted that, the ECU may be divided into a motor ECU, which is for motor control to control the motor 10, and an AT-ECU, which is for solenoid control. Hereinafter, a drive control of the motor 10 will be mainly described.

The ECU 50 includes an angle calculation unit 51, a target setting unit 52, a mode selection unit 53, a drive control unit 54, an abnormality monitoring unit 55, a notification unit 56, and the like. The angle calculation unit 51 counts pulse edges of each phase of an encoder signal output from the encoder 13, and calculates an encoder count value θen. The encoder count value θen is a value corresponding to the rotation position of the motor 10 and corresponds to a “motor angle”

The target setting unit 52 determines a target shift range according to the driver required shift range and the like. Further, a target count value θcmd, which is a position where the motor 10 is stopped, is set according to the target shift range.

The mode selection unit 53 selects the drive mode. The drive control unit 54 generates a drive signal related to the drive control of the motor 10 so that the detent roller 26 fits into the valley portions 221 to 224 according to the target shift range according to the selected drive mode. The generated drive signal is output to the drive circuit 41. The drive of the motor 10 is controlled by switching the switching elements 411 to 416 on and off according to the drive signal and controlling the energization of the motor winding 11.

When the target shift range is changed, the drive control unit 54 drives the motor 10 by feedback control. In the drawing, the feedback is described as “F/B”. Specifically, the motor 10 is rotated by energizing the energizing phase according to an encoder count value θen and switching the energizing phase according to the encoder count value θen. When the encoder count value θen falls within a predetermined range including the target count value θcmd (for example, ±2 counts), the feedback control is switched to the stop control and the motor 10 is stopped. Hereinafter, when the encoder count value θen falls within a predetermined range including the target count value θcmd, it is defined as “reaching the target”.

The abnormality monitoring unit 55 monitors an abnormality of the shift-by-wire system 1. The notification unit 56 notifies the driver of the abnormal state by displaying a warning according to the abnormal state on an instrument panel or the like (not shown). A notification method is not limited to the display on the instrument panel, and may be voice notification or the like.

In the present embodiment, a DC brushless motor is used as the motor 10. The DC brushless motor has a permanent magnet and generates cogging torque. Here, if the detent roller 26 cannot get over the mountain portion of the detent plate 21 due to, for example, insufficient torque due to low voltage or low current, mechanical lock due to foreign matter, or the like, there is a risk that the detent roller 26 will stop at an intermediate position due to cogging torque. If the detent roller 26 stops at the intermediate position, the manual valve 28 cannot be controlled to an appropriate position. Hereinafter, the stagnation due to mechanical factors is referred to as “mechanical lock”.

Therefore, in the present embodiment, when a stagnation abnormality that stagnates at the intermediate position occurs due to an increase in load torque, even if the detent roller 26 cannot be driven to the target position, it is noted that it is possible to generate the torque for returning to any of the valley portions 221 to 224. Then, the motor 10 is controlled so as to return the detent roller 26 from the intermediate position to any of the valley portions 221 to 224. In the present embodiment, the area outside the control range corresponding to each range is defined as the “intermediate position”. Further, the stagnation abnormality due to insufficient torque due to low voltage or low current is referred to as “low voltage low current abnormality”, and the stagnation abnormality due to mechanical lock is referred to as “mechanical lock abnormality”.

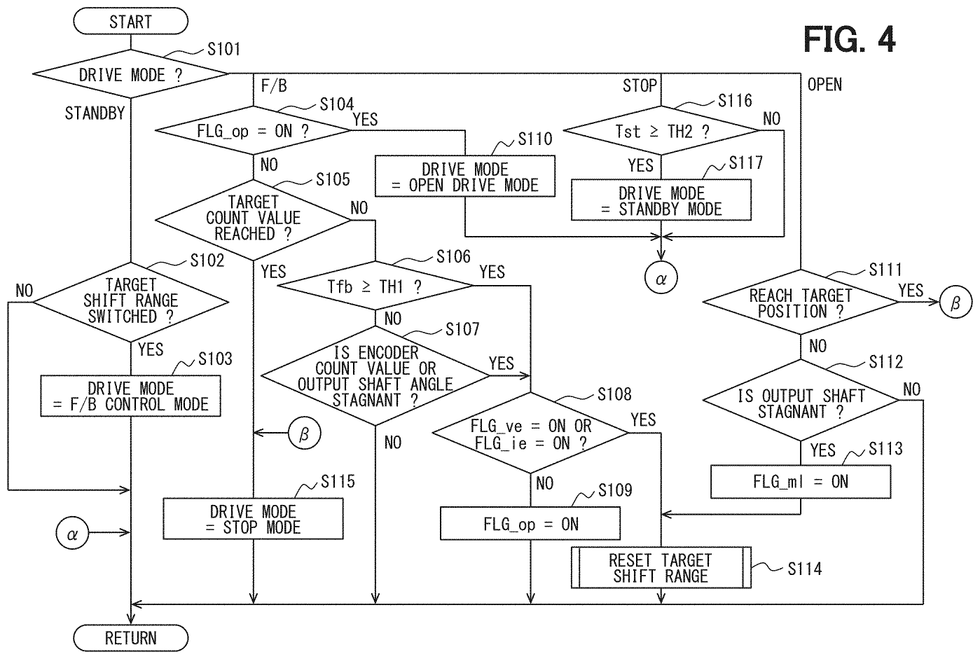

This drive mode selection process in the present embodiment will be described with reference to a flowchart of FIG. 4. This process is executed in a predetermined cycle (for example, 1 [ms]) by, for example, the mode selection unit 53 of the ECU 50. A part of the process may be executed by another calculation unit of the ECU 50. The same applies to other control processes. Further, the calculation cycle may be the same or different for each process. Hereinafter, “step” in step S101 is omitted, and is simply referred to as a symbol “S.” The same applies to the other steps.

In S101, the ECU 50 determines the drive mode. The process proceeds to S102 when the drive mode is a standby mode, the process proceeds to S104 when the drive mode is a feedback control mode, the process proceeds to S111 when the drive mode is an open drive mode, and the process proceeds to S116 when the drive mode is a stop mode.

In S102, the ECU 50 determines whether or not the target shift range has been changed to another. The target shift range is described as “target range” as appropriate in the figure. When it is determined that the target shift range has not been switched (S102: NO), the standby mode is continued. When it is determined that the target shift range has been switched (S102: YES), the drive mode is switched to the feedback control mode, and the motor 10 is driven by the feedback control.

In S104, which shifts when the drive mode is the feedback control mode, the ECU 50 determines whether or not an open drive request flag FLG_op is turned on. When it is determined that the open drive request flag FLG_op is turned on (S104: YES), the process proceeds to S110 and the drive mode is switched to the open drive mode. In the open drive mode, the motor 10 is driven by an open control that switches the energizing phase at predetermined time intervals without using the encoder count value θen. When it is determined that the open drive request flag FLG_op is not turned on (S104: NO), the process proceeds to S105.

In S105, the ECU 50 determines whether or not the encoder count value θen has reached the target count value θcmd. When it is determined that the encoder count value θen has reached the target count value θcmd (S105: YES), the process proceeds to S115, the drive mode is switched to the stop mode, and the motor 10 is stopped by stop control. In the present embodiment, the motor 10 is stopped by a fixed phase energization that energizes the predetermined two phases according to the rotor position, but the motor 10 may be stopped by a method other than the fixed phase energization. In addition, a time counting of a stop mode elapsed time Tst, which is the elapsed time from the start of the stop mode, is started. When it is determined that the encoder count value θen has not reached the target count value θcmd (S105: NO), the process proceeds to S106.

In S106, the ECU 50 determines whether or not a drive mode elapsed time Tfb is equal to or greater than the elapsed determination value TH1. The elapsed determination value TH1 is set to a time longer than the time required for range switching in the normal state. When it is determined that the drive mode elapsed time Tfb is equal to or greater than the elapsed determination value TH1 (S106: YES), the process proceeds to S108. When it is determined that the drive mode elapsed time Tfb is less than the elapsed determination value TH1 (S106: NO), the process proceeds to S107.

In S107, the ECU 50 determines whether or not the encoder count value θen or the output shaft angle θs is stagnant. Here, when an encoder stagnation time Tenc, which will be described later, is equal to or longer than an encoder stagnation determination time Testp, it is determined that the encoder count value θen is stagnant. Further, when an output shaft stagnation time Tout1 at the time of feedback control is equal to or longer than an output shaft stagnation determination time Tostp1, it is determined that the output shaft angle θs is stagnant. When it is determined that the encoder count value θen and the output shaft angle θs are not stagnant (S107: NO), the feedback control is continued. When it is determined that the encoder count value θen or the output shaft angle θs is stagnant (S107: YES), the process proceeds to S108.

In S108, the ECU 50 determines whether or not a low voltage abnormality flag FLG_ve or a low current abnormality flag FLG_ie is turned on. When it is determined that the low voltage abnormality flag FLG_ve and the low current abnormality flag FLG_ie are not turned on (S108: NO), the process proceeds to S109 and an open drive request flag FLG_op is turned on. When it is determined that the low voltage abnormality flag FLG_ve or the low current abnormality flag FLG_ie is turned on (S108: YES), a stagnation abnormality due to insufficient torque due to low voltage or low current is confirmed, and the process proceeds to S114 so as to reset the target shift range. Details of resetting the target shift range will be described later.

In S111, which proceeds when the drive mode is the open drive mode, the ECU 50 determines whether or not the detent roller 26 has reached the target position. Since the encoder count value θen is not used in the open drive mode, the determination of reaching the target position is preformed based on, for example, the output shaft angle θs. When it is determined that the detent roller 26 has reached the target position (S111: YES), the process proceeds to S115 and the drive mode is switched to the stop mode. When it is determined that the detent roller 26 has not reached the target position (S111: NO), the process proceeds to S112.

In S112, the ECU 50 determines whether or not the output shaft 15 is stagnant. Here, when an output shaft stagnation time Tout2 at the time of open drive is equal to or longer than an output shaft stagnation determination time Tostp2, it is determined that the output shaft angle θs is stagnant. When it is determined that the output shaft 15 is not stagnant (S112: NO), the open drive is continued. When it is determined that the output shaft 15 is stagnant (S112: YES), the process proceeds to S113 and a mechanical lock abnormality flag FLG_ml is turned on. Then, it proceeds to S114.

In S116, which proceeds when the drive mode is the stop mode, the ECU 50 determines whether or not the stop mode elapsed time Tst is equal to or greater than the elapsed determination value TH2. The elapsed determination value TH2 is set according to the time required to reliably stop the motor 10. When it is determined that the stop mode elapsed time Tst is less than the elapsed determination value TH2 (S116: NO), the stop mode is continued. When it is determined that the stop mode elapsed time Tst is equal to or greater than the elapsed determination value TH2 (S116: YES), the process proceeds to S117 and the drive mode is switched to the standby mode.

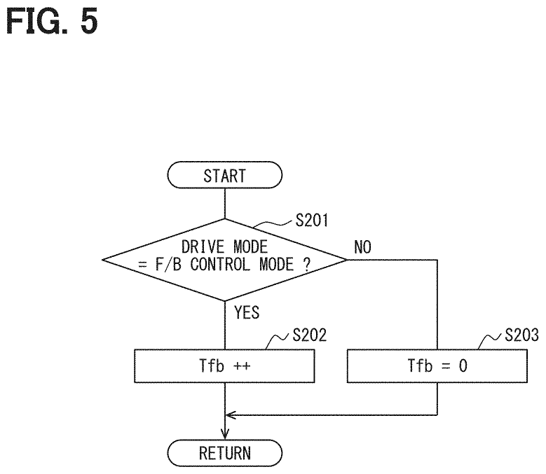

A drive mode elapsed time calculation process will be described with reference to the flowchart of FIG. 5. In S201, the ECU 50 determines whether or not the drive mode is the feedback control mode. When it is determined that the drive mode is the feedback control mode (S201: YES), the process proceeds to S202 and the drive mode elapsed time Tfb is incremented. When it is determined that the drive mode is not the feedback control mode (S201: NO), the process proceeds to S203 and the drive mode elapsed time Tfb is reset. Here, the time counting of the drive mode elapsed time Tfb is measured by a counter, but a timer or the like may be used, for example. The same applies to the time counting of other elapsed times.

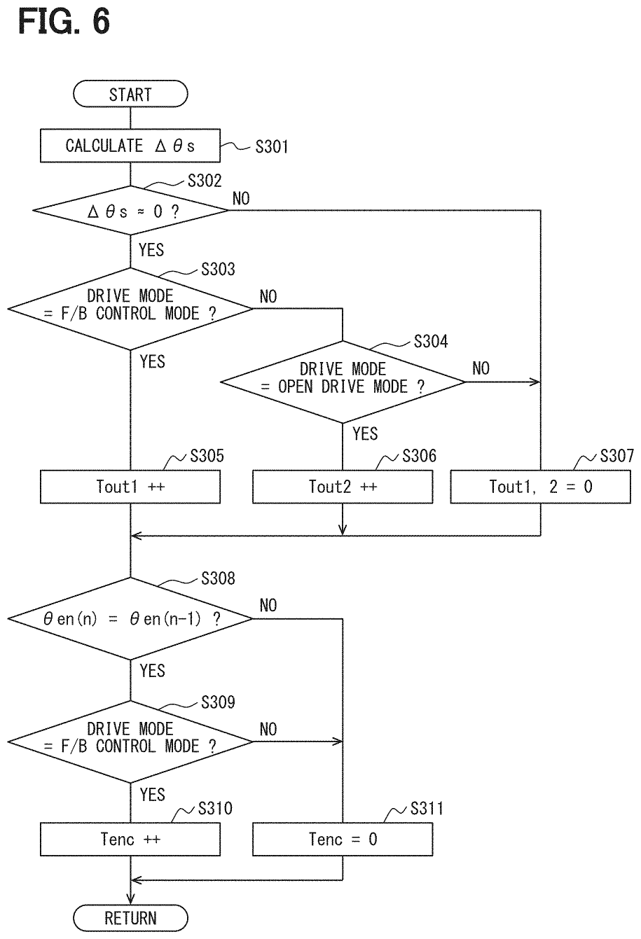

A stagnation detection process for determining the stagnation of the encoder count value Ben or the output shaft angle θs will be described with reference to the flowchart of FIG. 6. In S301, the ECU 50 calculates an output shaft change amount Δθs (see equation (1)). Hereinafter, the subscript (n) is a current value, and (n−1) is a previous value.

Δθs=θs (n−1)−θs (n) (1)

In S302, the ECU 50 determines whether or not the output shaft change amount Δθs is substantially 0. Here, when an absolute value of the output shaft change amount Δθs is less than or equal to a stagnation determination value θs_th set to a value that can be regarded as 0, the output shaft change amount Δθs is regarded as substantially 0. When it is determined that the output shaft change amount Δθs is not substantially 0 (S302: NO), that is, when the output shaft 15 is driven, the process proceeds to S307 and the output shaft stagnation times Tout1 and Tout2 are reset. When it is determined that the output shaft change amount Δθs is substantially 0 (S302: YES), that is, when the output shaft 15 is stopped, the process proceeds to S303.

In S303, the ECU 50 determines whether or not the drive mode is the feedback control mode. When it is determined that the drive mode is the feedback control mode (S303: YES), the process proceeds to S305, and the output shaft stagnation time Tout1 at the time of feedback control is incremented. When it is determined that the drive mode is not the feedback mode (S303: NO), the process proceeds to S304.

In S304, the ECU 50 determines whether the drive mode is the open drive mode. When it is determined that the drive mode is the open drive mode (S304: YES), the process proceeds to S306, and the output shaft stagnation time Tout2 at the time of open drive is incremented. When it is determined that the drive mode is not the feedback control mode or the open drive mode (S303: NO and S304: NO), the process proceeds to S307 and the output shaft stagnation times Tout1 and Tout2 are reset.

In S308, the ECU 50 determines whether or not the current value of the encoder count value θen is the same as the previous value thereof. When it is determined that the current value of the encoder count value θen is different from the previous value (S308: NO), the process proceeds to S311 and the encoder stagnation time Tenc is reset. When it is determined that the current value of the encoder count value θen is the same as the previous value (S308: YES), the process proceeds to S309.

In S309, the ECU 50 determines whether or not the drive mode is the feedback control mode. When it is determined that the drive mode is the feedback control mode (S309: YES), the process proceeds to S310 and the encoder stagnation time Tenc is incremented. When it is determined that the drive mode is not the feedback control mode (S309: NO), the process proceeds to S311 and the encoder stagnation time Tenc is reset.

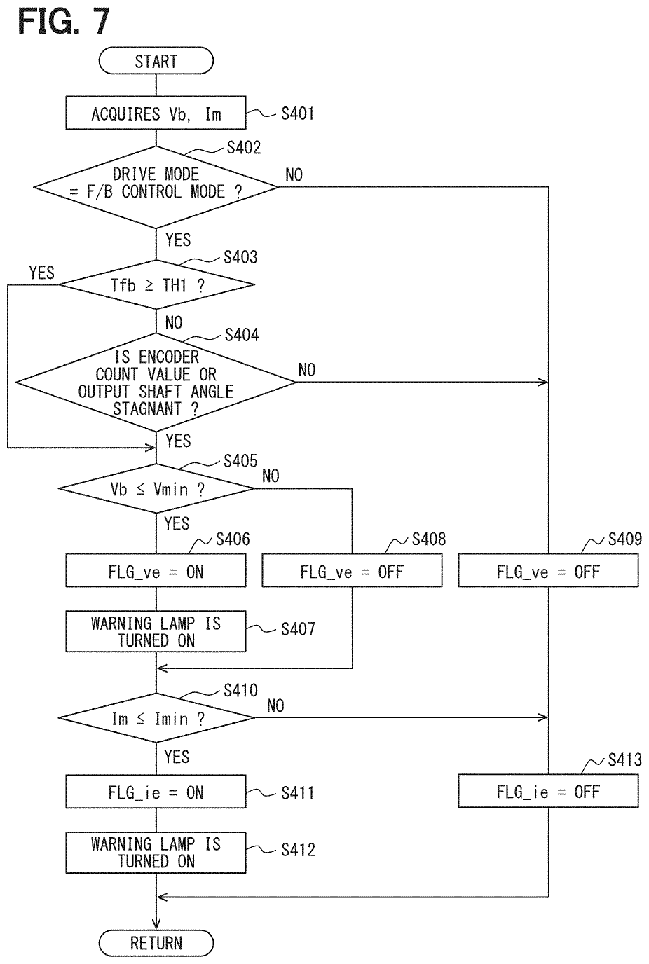

The low voltage and low current determination process will be described with reference to the flowchart of FIG. 7. This process is mainly executed by the abnormality monitoring unit 55. In S401, the ECU 50 acquires the battery voltage Vb, which is the input voltage and the motor current Im. In S402, the ECU 50 determines whether or not the drive mode is the feedback control mode. When it is determined that the drive mode is not the feedback control mode (S402: NO), the process proceeds to S409 to turn off the low voltage abnormality flag FLG_ve, and then to turn off the low current abnormality flag FLG_ie in S413. When it is determined that the drive mode is the feedback control mode (S402: YES), the process proceeds to S403.

In S403, the ECU 50 determines whether or not the drive mode elapsed time Tfb is equal to or greater than the elapsed determination value TH1. When it is determined that the drive mode elapsed time Tfb is equal to or greater than the elapsed determination value TH1 (S403: YES), the process proceeds to S405. When it is determined that the drive mode elapsed time Tfb is less than the elapsed determination value TH1 (S403: NO), the process proceeds to S404.

In S404, it is determined whether or not the encoder count value θen or the output shaft angle θs is stagnant. The details of the determination are the same as in S107 in FIG. 4. When it is determined that the encoder count value θen and the output shaft angle θs are not stagnant (S404: NO), in S409 and S413, the low voltage abnormality flag FLG_ve and the low current abnormality flag FLG_ie are turned off, similar to the case where the negative determination is made in S402. When it is determined that the encoder count value θen or the output shaft angle θs is stagnant (S404: YES), the process proceeds to S405.

In S405, the ECU 50 determines whether or not the battery voltage Vb is equal to or less than the low voltage determination value Vmin. The low voltage determination value Vmin is set according to the voltage at which the torque required for range switching can be output. When it is determined that the battery voltage Vb is larger than the low voltage determination value Vmin (S404: NO), the process proceeds to S408 and the low voltage abnormality flag FLG_ve is turned off. When it is determined that the battery voltage Vb is equal to or less than the low voltage judgment value Vmin (S405: YES), the process proceeds to S406, the low voltage abnormality flag FLG_ve is turned on, and a warning lamp of an instrument panel (not shown) is turned on in S407.

In S410 that proceeds following S407 or S408, the ECU 50 determines whether or not the motor current Im is equal to or less than the low current determination value Imin. The low current determination value Imin is set according to the current that can output the torque required for range switching. When it is determined that the motor current Im is larger than the low current determination value Imin (S410: NO), the process proceeds to S413 and the low current abnormality flag FLG_ie is turned off. When it is determined that the motor current Im is equal to or less than the low current determination value Imin (S410: YES), the process proceeds to S411, the low current abnormality flag FLG_ie is turned on, and the warning lamp on the instrument panel is turned on in S412.

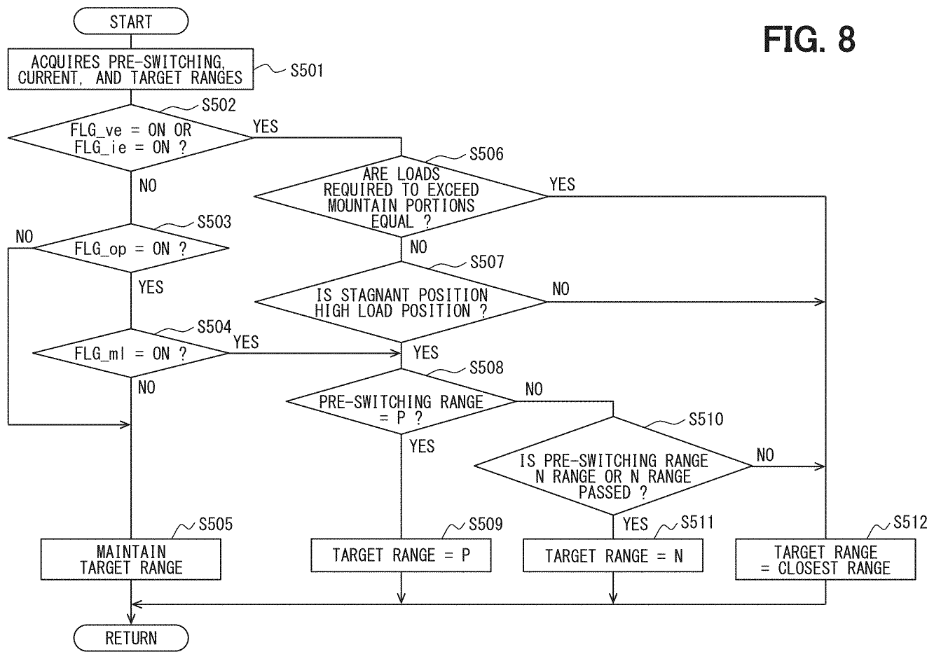

A target range resetting process will be described with reference to the flowchart of FIG. 8. This process is a subflow executed in S114 in FIG. 4, and is mainly executed by the target setting unit 52. In S501, the ECU 50 acquires the pre-switching range, the current range, and the target range.

In S502, the ECU 50 determines whether or not the low voltage abnormality flag FLG_ve or the low current abnormality flag FLG_ie is turned on. When it is determined that the low voltage abnormality flag FLG_ve or the low current abnormality flag FLG_ie is turned on (S502: YES), the process proceeds to S506. When it is determined that the low voltage abnormality flag FLG_ve and the low current abnormality flag FLG_ie are not turned on (S502: NO), the process proceeds to S503.

In S503, the ECU 50 determines whether or not the open drive request flag FLG_op is turned on. When it is determined that the open drive request flag FLG_op is not turned on (S503: NO), the process of S504 is not executed, the process proceeds to S505, and the target shift range is maintained. When it is determined that the open drive request flag FLG_op is turned on (S503: YES), the process proceeds to S504.

In S504, the ECU 50 determines whether or not the mechanical lock abnormality flag FLG_ml is turned on. When it is determined that the mechanical lock abnormality flag FLG_ml is turned on (S504: YES), the process proceeds to S508. When it is determined that the mechanical lock abnormality flag FLG_ml is not turned on (S504: NO), the process proceeds to S505 and the target range is maintained.

In S506, which proceeds to the case where it is determined that the low voltage abnormality flag FLG_ve or the low current abnormality flag FLG_ie is turned on (S502: YES), the ECU 50 determines whether or not the loads required for the detent roller 26 to exceed the mountain portions 226 to 228 of the detent plate 21 are equal. Here, depending on the shape of the detent plate 21, a positive determination is made when the heights of the mountain portions 226 to 228 are equal, and a negative determination is made when, for example, the mountain portion 226 between PR is higher than the other mountain portions 227 and 228. That is, since the determination of S506 is determined by the shape of the detent plate 21, unnecessary processes after S507 can be appropriately omitted depending on the shape of the detent plate 21. When it is determined that all the loads required to exceed mountain portions 226 to 228 are equal (S506: YES), the process proceeds to S512. When it is determined that the loads required to exceed the mountain portions 226 to 228 are different (S506: NO), the process proceeds to S507.

In S507, the ECU 50 determines whether or not the stagnant position of the detent roller 26 is a position where the load required to exceed the current mountain portion is higher than that of other mountain portions (hereinafter, referred to as “high load position”). When the mountain portion 226 between the PRs is higher than the other mountain portions as in the present embodiment, the position where the detent roller 26 faces the apex of the mountain portion 226 corresponds to the “high load position”. When it is determined that the stagnant position of the detent roller 26 is not the high load position (S507: NO), the process proceeds to S512. When it is determined that the stagnant position of the detent roller 26 is the high load position (S507: YES), the process proceeds to S508.

In S508, the ECU 50 determines whether or not the pre-switching range is the P range. When it is determined that the pre-switching range is the P range (S508: YES), the process proceeds to S509 and the target shift range is switched to the P range. When it is determined that the pre-switching range is not the P range (S508: NO), the process proceeds to S510.

In S510, the ECU 50 determines whether or not the pre-switching range is the N range or has passed the N range before the current position. “Passing the N range” means that the detent roller 26 has passed the valley portion 223 corresponding to the N range from the start of the range switching to the stagnation. When it is determined that the pre-switching range is the N range or has passed the N range before the current position (S510: YES), the process proceeds to S511 and the target shift range is switched to the N range. When it is determined that the pre-switching range is other than the P range and the N range and has not been passed the N range before the current position (S510: NO), the process proceeds to S512. In S512, the ECU 50 sets the target range as the closest range in a direction in which the detent roller 26 is returned.

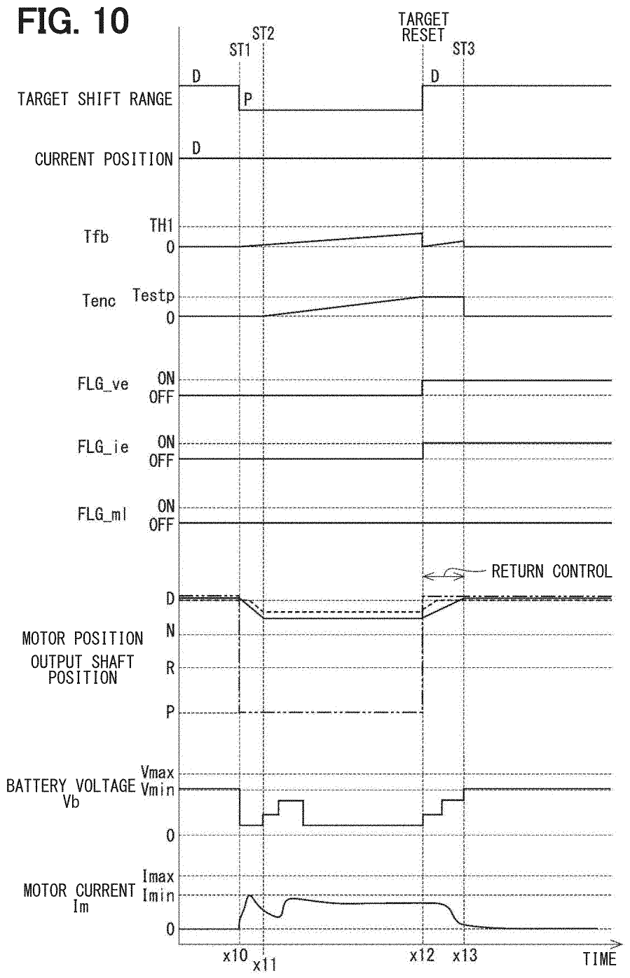

A specific example of a range switching process will be described with reference to FIGS. 9 to 20. FIGS. 9, 11, 13, 15, 17 and 19 schematically show the detent plate 21, the detent roller 26 and the like. FIGS. 10, 12, 14, 16, 18 and 20 is a time chart corresponding to FIGS. 9, 11, 13, 15, 15, 17, and 19, respectively.

Actually, the detent roller 26 moves in the valley portions 221 to 224 by driving the detent plate 21, but FIGS. 9, 11, 13, 15, 17, and 19 shows a state in which the detent roller 26 moves on the detent plate 21. Further, in FIG. 9 and the like, a switching start position is set to ST1, a stagnant position of the detent roller 26 is set to ST2, a return position is set to ST3, and the detent roller 26 and the like in a stagnant state are shown by broken lines.

In the present embodiment, the mountain portion 226 between the PRs is formed higher than the other mountain portions 227 and 228. Therefore, the torque required for the detent roller 26 to get over the mountain portion 226 is larger than the torque required to get over the mountain portion 227 and 228. In FIGS. 9, 11 and 13, the detent torque applied to the detent roller 26 is shown in the lower row, and the torque when the detent plate 21 rotates in a forward direction is described as positive and the torque when the detent plate 21 is rotated in a reverse direction is described as negative. An actual torque Tm that can be output by the motor 10 is described as a single point chain line.

In FIG. 10, from the upper row, the target shift range, the current position of the detent roller 26, the drive mode elapsed time Tfb, the encoder stagnation time Tenc, the low voltage abnormality flag FLG_ve, the low current abnormality flag FLG_ie, the mechanical lock abnormality flag FLG_ml, the motor position and the output shaft position, the battery voltage Vb, and the motor current Im are shown. The current position of the detent roller 26 is described as P when the detent roller 26 is on the valley portion 221 side with respect to the mountain portion 226, is described as R when it is between the mountain portions 226 and 227, is described as N when it is between the mountain portions 227 and 228, and is described as D when it is on the valley 224 portion side with respect to the mountain portion 228. For the motor position and output shaft position, the encoder count value θen is described as a solid line, the output shaft angle θs is described as a broken line, and the target count value θcmd is described as a two-dot chain line. The output shaft angle θs is a value converted by a gear ratio so as to match the encoder count value θen, Further, the target count value θcmd is a value set in the feedback control mode, but for the sake of explanation, it is described as a value corresponding to the target shift range even in the open drive.

In addition, the corresponding ranges P, R, N, and D are described at the positions corresponding to the bottoms of the valley portions 221 to 224. Here, the “bottom of the valley portion” is defined as a range corresponding to the allowable stop range of the output shaft 15, and the state in which the detent roller 26 is located at the bottom of the valley portion is defined as “the engagement member fits into the valley portion”. Further, the range between the low voltage determination value Vmin and the overvoltage determination value Vmax is the normal range of the battery voltage Vb, and the range between the low current determination value IIIim and the overcurrent determination value Imax is the normal range of the motor current Im.

FIGS. 9 and 10 show a case of switching from the D range to the P range. As shown in FIG. 9, when the detent roller 26 cannot get over the mountain portion 228 due to insufficient torque, even if the detent roller 26 cannot get over the mountain portion 228, the torque to return the detent roller 26 to the valley portion 224 can be generated so that the detent roller 26 returns to the valley portion 224.

As shown in FIG. 10, when the target shift range is switched from the D range to the P range at the time x10, the motor 10 is driven in the feedback control mode, and the time counting of the drive mode elapsed time Tfb is started. When the encoder count value θen stagnates at the time x11, the time counting of the encoder stagnant time Tenc is started.

When the encoder stagnation time Tenc reaches the encoder stagnation determination time Testp at the time x12, the battery voltage Vb is lower than the low voltage determination value Vmin, so the low voltage abnormality flag FLG_ve is turned on. Further, since the motor current Im is smaller than the low current determination value Imin, the low current abnormality flag FLG_ie is turned on. In the present embodiment, when the encoder stagnation time Tenc becomes the encoder stagnation determination time Testp, if it is in a low voltage and low current abnormal state, the stagnation abnormality is determined. Then, the target shift range is switched from the P range to the D range, and the return control is started.

When the detent roller 26 returns to the bottom of the valley portion 224 at the time x13, the process ends. In the time chart, the description of stop control is omitted. Further, in the case of feedback control, the stagnation determination may be made by using the output shaft stagnation time Tout1 at the time of feedback instead of the encoder stagnation time Tenc, or be made by using the encoder stagnation time Tenc and the output shaft stagnation time Tout1 together.

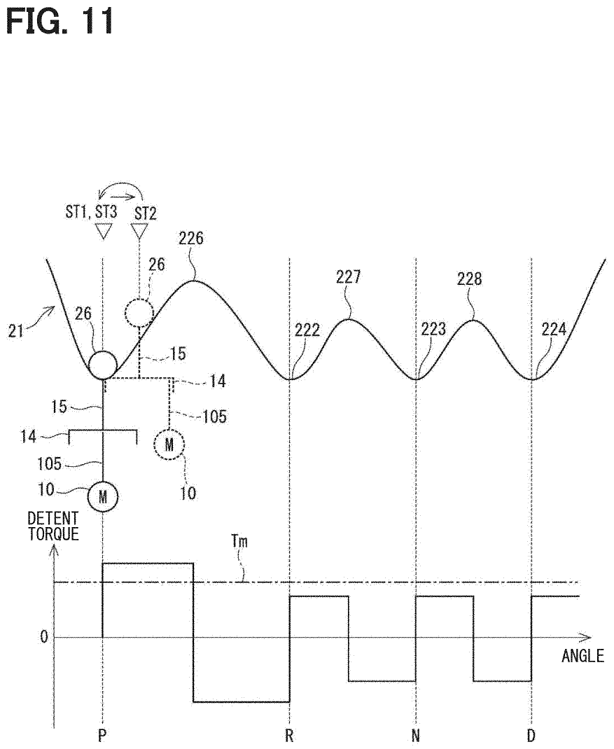

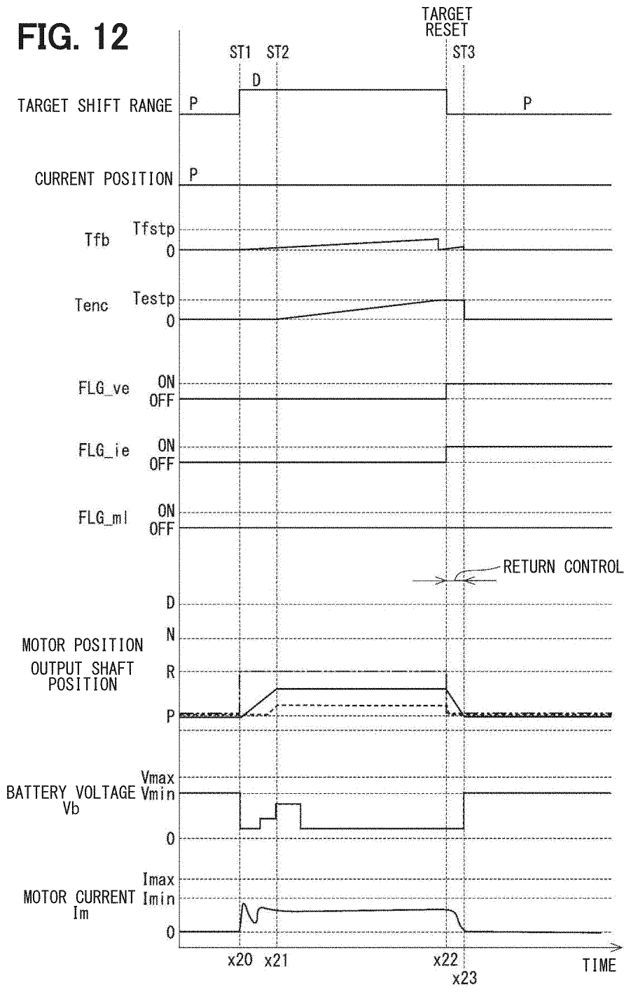

FIGS. 11 and 12 show a case of switching from the P range to the D range. As shown in FIG. 11, when the detent roller 26 cannot get over the mountain portion 226 due to insufficient torque, even if the detent roller 26 cannot get over the mountain portion 226, the torque to return the detent roller 26 to the valley portion 221 can be generated so that the detent roller 26 returns to the valley portion 221.

As shown in FIG. 12, when the target shift range is switched from the P range to the D range at the time x20, the motor 10 is driven in the feedback control mode, and the time counting of the drive mode elapsed time Tfb is started. When the encoder count value θen stagnates at the time x21, the time counting of the encoder stagnant time Tenc is started.

When the encoder stagnation time Tenc reaches the encoder stagnation determination time Testp at the time x22, the battery voltage Vb is lower than the low voltage determination value Vmin, so the low voltage abnormality flag FLG_ve is turned on. Further, since the motor current Im is smaller than the low current determination value Imin, the low current abnormality flag FLG_ie is turned on. Then, the target shift range is switched from the D range to the P range, and the return control is started. When the detent roller 26 returns to the bottom of the valley portion 221 at the time x23, the process ends.

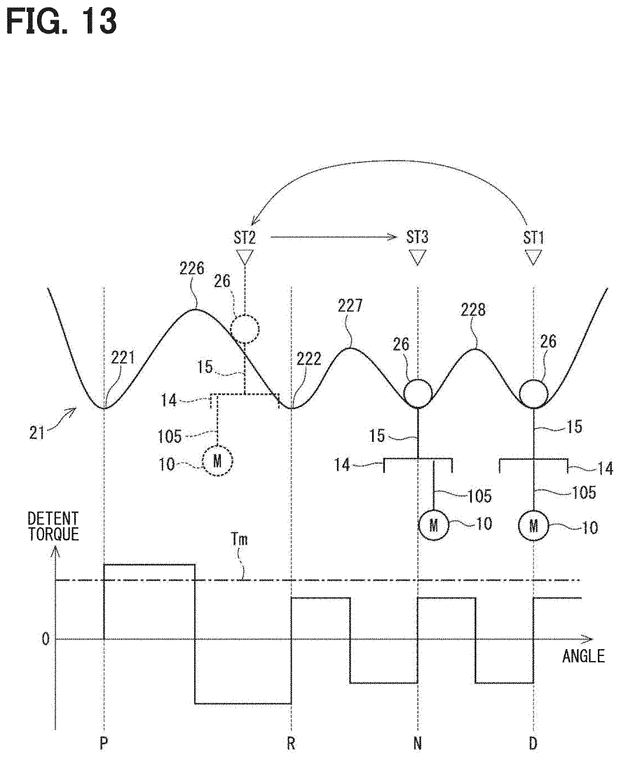

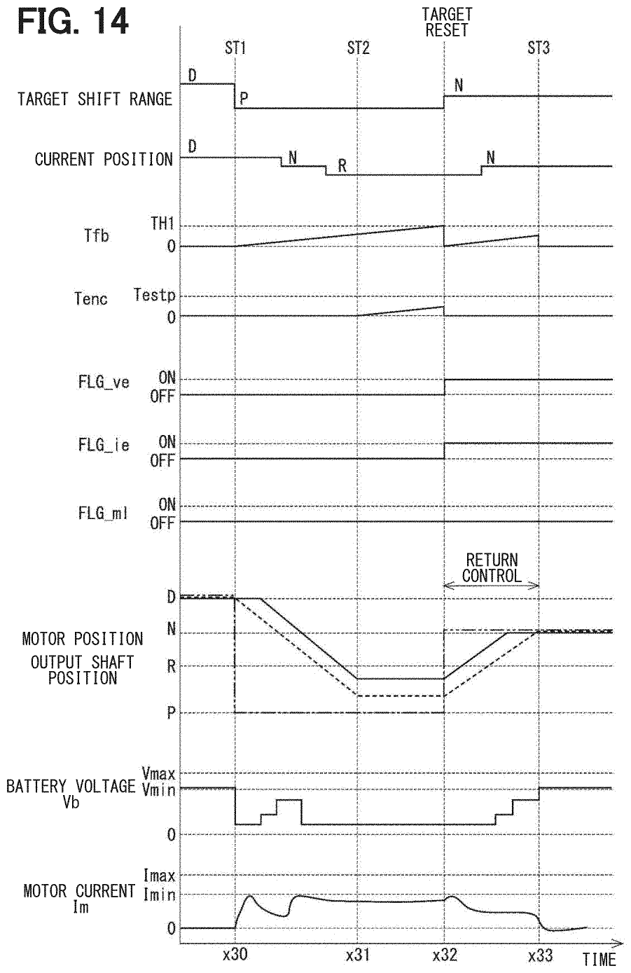

FIGS. 13 and 14 show a case of switching from the D range to the P range. In this example, the detent roller 26 can generate torque to get over the mountain portions 227 and 228, but cannot get over the mountain portion 226, and the detent roller 26 is stagnant on the R range side with respect to the mountain portion 226, which is a high load position. In this case, since there is the valley portion 223 corresponding to the N range which is a non-driving range in the return direction, the detent roller 26 is returned to the valley portion 223.

As shown in FIG. 14, the process at the time x30 is the same as the process at the time x16 in FIG. 12. In the process at the time x31, the stop position of the detent roller 26 is different from the stop position at the time x11 in FIG. 12. However, the process is the same as the time x11 in FIG. 12, and when the encoder count value θen is stagnant, the time counting of the encoder stagnant time Tenc is started.

When the drive mode elapsed time Tfb reaches the elapsed determination value TH1 at the time x32, the battery voltage Vb is lower than the low voltage determination value Vmin, so the low voltage abnormality flag FLG_ve is turned on. Further, since the motor current Im is smaller than the low current determination value Imin, the low current abnormality flag FLG_ie is turned on. Whether the drive mode elapsed time Tfb reaches the elapsed judgment value TH1 or the encoder stagnation time Tenc reaches the encoder stagnation judgment time Test, which comes first is determined by the setting of the judgment value and the stagnant position of the detent roller 26.

Here, since there is the valley portion 223 corresponding to the N range which is the non-driving range in the return direction, the target shift range is switched from the P range to the N range, and the return control is started. That is, here, the return control is controlled so that the detent roller fits into the valley portion corresponding to a range that is different from the range before switching and the original target range. When the detent roller 26 returns to the bottom of the valley portion 223 at the time x33, the process ends.

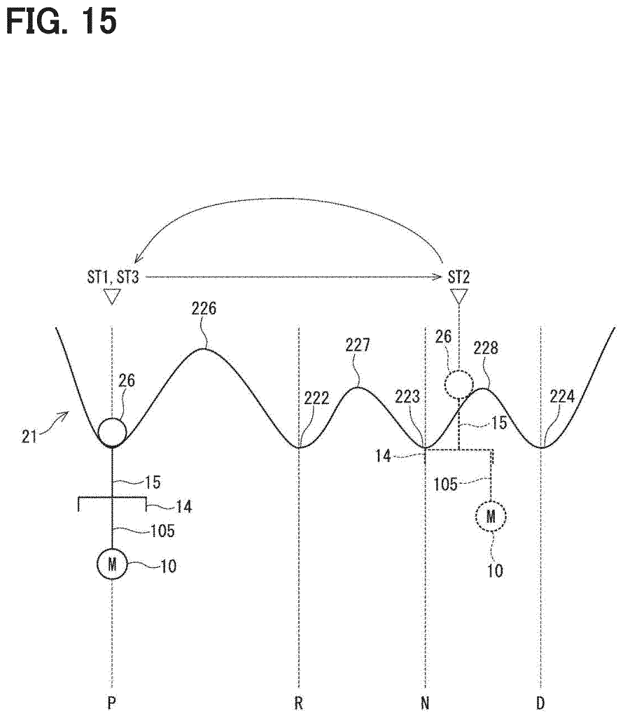

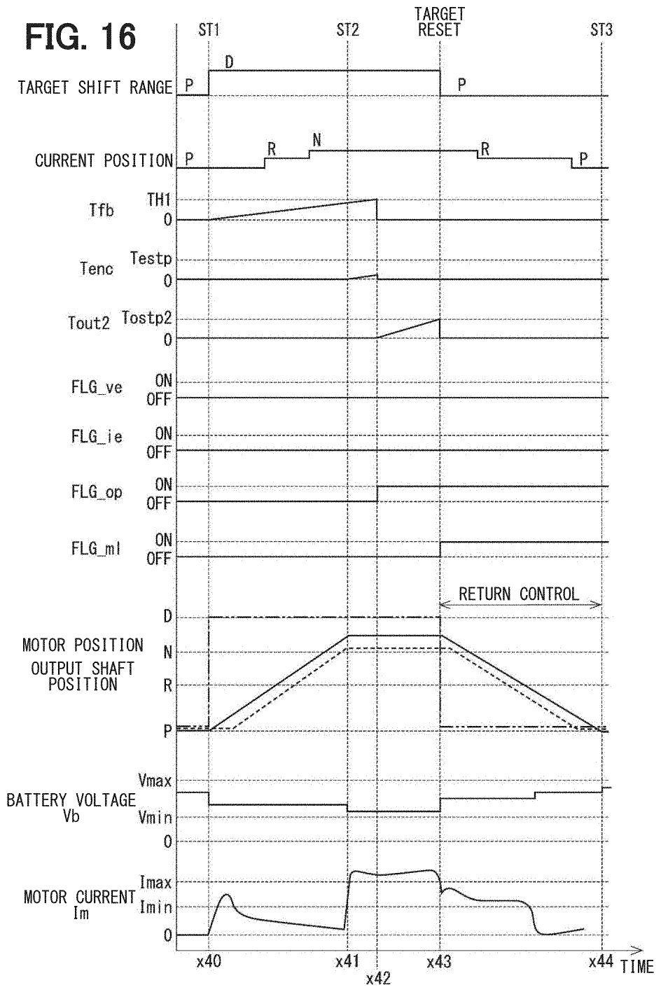

FIGS. 15 and 16 show a case of switching from the P range to the D range. In this example, although sufficient torque can be generated for range switching, the detent roller 26 is stopped by a mechanical lock between the valley portion 223 and the mountain portion 228 shown in ST2 in FIG. 15. The stagnation due to mechanical factors such as mechanical lock may occur not only while the detent roller 26 is climbing from the valley portion to the mountain portion, but also while the detent roller descends from the mountain portion to the valley portion. In the case of mechanical lock, the detent roller cannot go any further, but can return to any valley portion. Here, if the range before switching is the P range, the detent roller 26 is returned to the valley portion 221 corresponding to the P range which is the non-driving range.

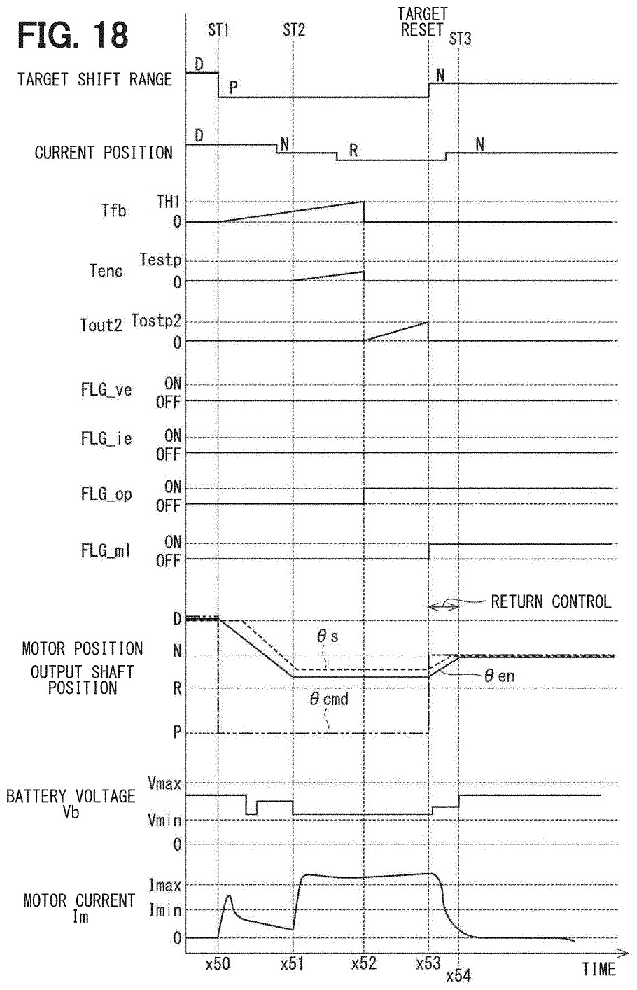

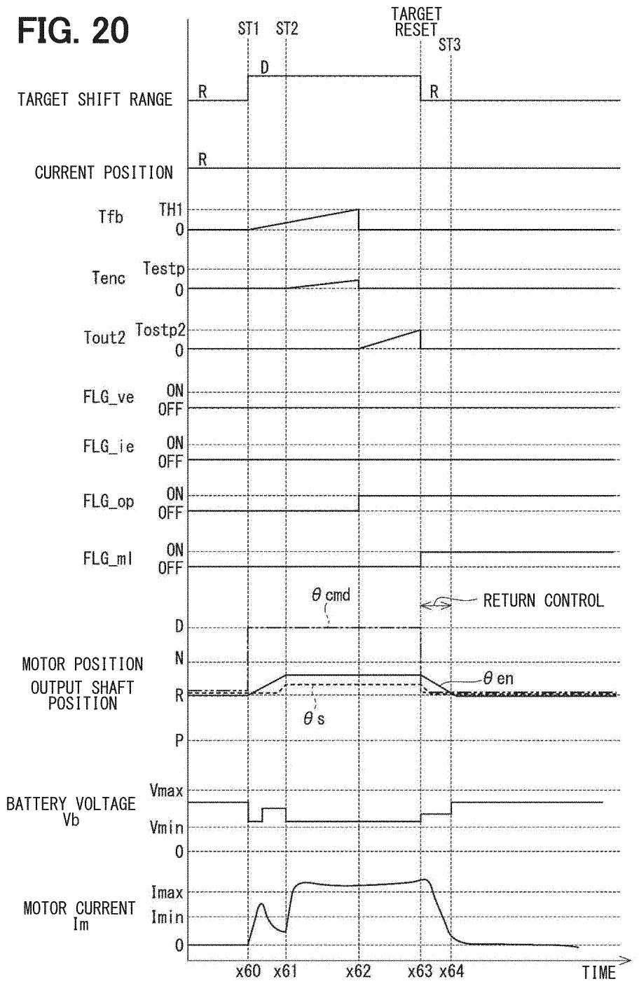

In FIG. 16, in addition to each item such as FIG. 10, the output shaft stagnation time Tout2 at the time of open drive and the open drive request flag FLG_op are described. The same applies to FIGS. 18 and 20. When the target shift range is switched from the P range to the D range at the time x40, the motor 10 is driven in the feedback control mode, and the time counting of the drive mode elapsed time Tfb is started. Further, when the encoder count value θen stagnates at the time x41, the time counting of the encoder stagnant time Tenc is started.

At the time x42, when the drive mode elapsed time Tfb reaches the elapsed determination value TH1, the battery voltage Vb is higher than the low voltage determination value Vmin, and the motor current Im is larger than the low current determination value Imin. That is, since it is not the low voltage low current abnormality, the low voltage abnormality flag FLG_ve and the low current abnormality flag FLG_ie are not turned on. At this stage, the range switching may not be completed due to factors other than the mechanical lock abnormality, such as an encoder signal abnormality, so the stagnation abnormality is not confirmed at this stage. Further, the open drive request flag FLG_op is turned on, the mode shifts to the open drive mode, and the time counting of the output shaft stagnation time Tout2 at the time of open drive is started.

If the stagnation of the output shaft angle θs is not resolved even if the drive control is performed in the open drive mode, it is determined that the mechanical lock abnormality has occurred. Then, at the time x43, when the output shaft stagnation time Tout2 becomes the output shaft stagnation determination time Tostp2, the mechanical lock abnormality flag FLG_ml is turned on. That is, when the drive mode elapsed time Tfb reaches the elapsed determination value TH1, or when the encoder stagnation time Tenc reaches the encoder stagnation determination time Testp, the drive mode shifts to the open drive unless it is in the low voltage and low current abnormal state. Then, if the range switching is not completed even in the open drive, the stagnation abnormality is confirmed.

Then, the target shift range is switched from the D range to the P range, and the return control is started. When the detent roller 26 returns to the bottom of the valley portion 221 at the time x44, the process ends. In the present embodiment, the return control is performed in the open drive mode when the mechanical lock is abnormal, but if the encoder count value θen is normal, the return control may be performed in the feedback control mode.

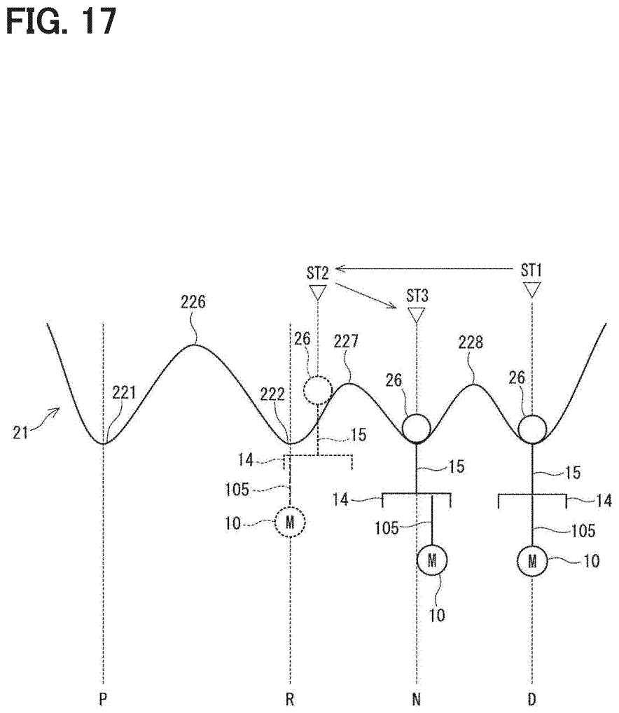

FIGS. 17 and 18 show a case of switching from the D range to the P range. In this example, although sufficient torque can be generated for range switching, the detent roller 26 is stopped by a mechanical lock between the mountain portion 227 and the valley portion 222 shown in ST2 in FIG. 17. Here, since the detent roller 26 has passed through the valley portion 223 corresponding to the N range, which is the non-driving range, by the time the detent roller 26 reaches ST2, the detent roller 26 is returned to the valley portion 223.

As shown in FIG. 18, when the target shift range is switched from the D range to the P range at the time x50, the motor 10 is driven in the feedback control mode, and the time counting of the drive mode elapsed time Tfb is started. When the encoder count value θen stagnates at the time x51, the time counting of the encoder stagnant time Tenc is started.

The process of the time x52 is the same as the process of the time x42 in FIG. 16, and when the drive mode elapsed time Tfb becomes the elapsed determination value TH1, it is not the low voltage low current abnormality, so the low voltage abnormality flag FLG_ve and the low current abnormality flag FLG_ie are not turned on, the open drive request flag FLG_op is turned on, and the mode shifts to the open drive mode. In addition, the time counting of the output shaft stagnation time Tout2 at the time of open drive is started.

At the time x53, it is determined that a mechanical lock abnormality has occurred at time x43 when the output shaft stagnation time Tout2 becomes the output shaft stagnation determination time Tostp2, and the mechanical lock abnormality flag FLG_ml is turned on. Then, the target shift range is switched from the P range to the N range, and the return control is started. When the detent roller 26 returns to the bottom of the valley portion 223 at the time x54, the process ends.

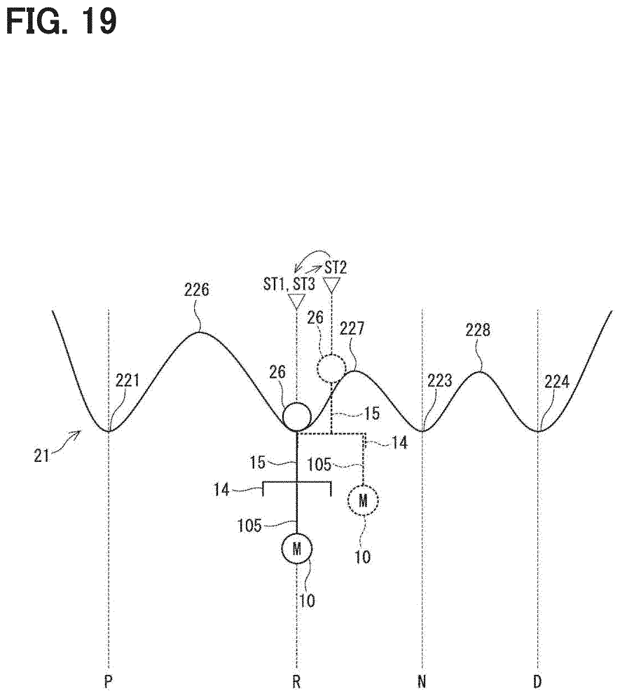

FIGS. 19 and 20 show a case of switching from the R range to the D range. The detent roller 26 is stopped by a mechanical lock between the valley portion 222 and the mountain portion 227 shown in ST2 in FIG. 19. In this case, since the detent roller 26 is stopped before reaching the valley portion 223 corresponding to the N range, which is the non-driving range, the detent roller 26 is returned to the nearest valley portion 222.

As shown in FIG. 20, when the target shift range is switched from the R range to the D range at the time x60, the motor 10 is driven in the feedback control mode, and the time counting of the drive mode elapsed time Tfb is started. When the encoder count value θen stagnates at the time x61, the time counting of the encoder stagnant time Tenc is started.

The process of the time x62 is the same as the process of the time x42 in FIG. 16, and when the drive mode elapsed time Tfb becomes the elapsed determination value TH1, it is not the low voltage low current abnormality, so the low voltage abnormality flag FLG_ve and the low current abnormality flag FLG_ie are not turned on, the open drive request flag FLG_op is turned on, and the mode shifts to the open drive mode. In addition, the time counting of the output shaft stagnation time Tout2 at the time of open drive is started.

At the time x63, it is determined that a mechanical lock abnormality has occurred at time x63 when the output shaft stagnation time Tout2 becomes the output shaft stagnation determination time Tostp2, and the mechanical lock abnormality flag FLG_ml is turned on. Then, the target shift range is switched from the D range to the R range, and the return control is started. When the detent roller 26 returns to the bottom of the valley portion 222 at the time x64, the process ends.

In the case of mechanical lock, even if the detent roller 26 exceeds the mountain portion 227, if it stops before reaching the bottom of the valley portion 223 corresponding to the N range, it cannot proceed any further, so the detent roper returns to the valley portion 222 by the return control. Further, the detent roller 26 can be returned to the valley portion 221 as long as the torque for getting over the mountain portion 226 can be generated. Further, when the detent roller 26 passes through the valley portion 223 and is stopped by the mechanical lock between the valley portion 223 and the valley portion 224, the detent roller 26 is returned to the valley portion 223 corresponding to the N range.

In the present embodiment, when the stagnation abnormality occurs, it may be controlled to the shift range different from the driver required shift range. Therefore, the warning content is changed according to the shift range before the switching, the shift range required by the driver, and the shift range after the switching is completed.

If the shift range requested by the driver and the shift range when the switching is completed are different, the user is notified of the information that the normal range switching could not be performed. When the shift range before the switching and the shift range after the switching is completed match, the user is notified of the information that the range cannot be switched.

Further, when the shift range after the switching is completed is the P range, the user is notified of the information that the vehicle is not moving. When the shift range after the switching is completed is other than the P range, the user is notified of the information prompting the operation of the parking brake.

In the present embodiment, when the stagnation abnormality occurs, the detent roller 26 is prevented from stopping at an intermediate position by performing the return control so that the detent roller 26 fits into one of the valley portions 221 to 224. Therefore, the manual valve 28 can be controlled to a position corresponding to any range. Further, when the detent roller 26 can be returned to the P range or the N range which is the non-driving range by the return control, the detent roller 26 is returned to the valley portion 221 or the valley portion 223 so that the vehicle can be in a safer state.

As described above, the shift range control device 40 of the present embodiment controls the shift-by-wire system 1. The shift-by-wire system 1 includes the motor 10, the output shaft 15 driven by the motor 10, and the shift range switching mechanism 20. The shift range switching mechanism 20 includes the detent plate 21, the detent roller 26, and the detent spring 25. A plurality of valley portions 221 to 224 and mountain portions 226 to 228 separating the valley portions 221 to 224 are formed on the detent plate 21, and the detent plate 21 rotates together with the output shaft 15. The detent roller 26 can move the valley portions 221 to 224 by driving the motor 10. The detent spring 25 urges the detent roller 26 in a direction of fitting into the valley portions 221 to 224.

The ECU 50 of the shift range control device 40 includes the target setting unit 52, the drive control unit 54, and the abnormality monitoring unit 55. The target setting unit 52 sets a target shift range. The drive control unit 54 controls the drive of the motor 10 so that the detent roller 26 fits into the target valley portion, which is the valley portion 221 to 224 according to the target shift range. The abnormality monitoring unit 55 monitors an abnormality of the shift-by-wire system 1. In the present embodiment, the abnormality monitoring unit 55 detects the stagnation abnormality in which the detent roller 26 stagnates without reaching the target valley portion.

The drive control unit 54 drives the motor 10 so that the detent roller 26 fits in the valley portion on the side returning from the stagnant position when a stagnation abnormality is determined in which the detent roller 26 stagnates without reaching the target valley portion. As a result, even if a stagnation abnormality occurs, the detent roller 26 can be fitted into any of the valley portions 221 to 224 without stopping the detent roller 26 at the intermediate position, so that it is possible to prevent the manual valve 28 from stopping at the intermediate position.

When the stagnation abnormality is confirmed, the target setting unit 52 resets the target shift range according to at least one of the stagnant position and the shift range before the start of range switching. As a result, the detent roller 26 can be fitted into the appropriate valley portion 221 to 224 according to the occurrence of the stagnation abnormality.

When the stagnation abnormality is confirmed, the target setting unit 52 resets the range corresponding to the valley portion closest to the return side from the stagnant position to the target shift range. As a result, it is possible to prevent the manual valve 28 from stopping at the intermediate position.

When the stagnation abnormality is confirmed and there is a valley portion corresponding to the non-driving range on the side where the detent roller 26 is returned from the stagnant position, the target setting unit 52 resets the non-driving range to the target shift range.

Specifically, when the stagnation abnormality is confirmed and the shift range before the start of range switching is the P range, the non-driving range is set to the P range, and the target setting unit 52 resets the P range to the target shift range. As a result, the vehicle can be safely stopped.

Further, when the stagnation abnormality is confirmed and the N range has been passed from the start of the range switching to the stagnant position, the non-driving range is set to the N range, and the target setting unit 52 switches the N range to the target shift range. This makes it possible to prevent unintended driving of the vehicle.

The ECU 50 further includes a notification unit 56 that notifies the user that an abnormality has occurred when the driver request shift range and the shift range after the switching is completed are different. The notification unit 56 makes the warning content to be notified to the user different according to the shift range before the switching and the shift range after the switching is completed. As a result, the user can be appropriately notified of the abnormal occurrence.

In the present embodiment, the shift-by-wire system 1 is a shift range switching system”, the motor 10 is an “actuator”, the detent plate 21 is a “driven member”, the detent spring 25 is an “urging member”, and the detent roller 26 is an “engagement member”. Further, the “non-driving range” is a range in which the vehicle is not driven, and in the present embodiment, the P range and the N range correspond to the “non-driving range”.

### Other Embodiments

In the above embodiment, the motor rotation angle sensor that detects the rotation angle of the motor is the three-phase encoder. In another embodiment, the motor rotation angle sensor may be a two-phase encoder, or may be a resolver or the like as long as it can detect the rotation position of the rotor. In the present embodiment, the potentiometer was illustrated as an output shaft sensor. In other embodiments, the output shaft sensor may be something other than a potentiometer, or the output shaft sensor may be omitted.

According to the embodiments described above, the motor is a permanent magnet type three phase brushless motor. In other embodiments, the motor may be an SR motor or the like. According to the embodiments described above, the four valley portions are formed in the detent plate. As another embodiment, the number of the valley portions is not limited to four but may be any number. For example, a configuration may be employable where the number of the valley portions of the detent plate is two and where the P range and the not P range are switchable therebetween. Further, in the above embodiment, the mountain portion 226 between the PRs is formed higher than the other mountain portions 227 and 228. In other embodiments, the mountain portion 226 between the PRs may be at the same height as the other mountain portions 227 and 228. The shift range switching mechanism and the parking lock mechanism or the like may be different from those in the embodiments described above.

In the above embodiments, the decelerator is placed between the motor shaft and the output shaft. Although the details of the decelerator are not described in the embodiments described above, it may be configured by using, for example, a cycloid gear, a planetary gear, a spur gear that transmits torque from a reduction mechanism substantially coaxial with the motor shaft to a drive shaft, or any combination of these gears. As another embodiment, the decelerator between the motor shaft and the output shaft may be omitted, or a mechanism other than the decelerator reducer may be provided.

The control circuit and method described in the present disclosure may be implemented by a special purpose computer which is configured with a memory and a processor programmed to execute one or more particular functions embodied in computer programs of the memory. Alternatively, the control circuit described in the present disclosure and the method thereof may be realized by a dedicated computer configured as a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium. The present disclosure is not limited to the embodiment described above but various modifications may be made within the scope of the present disclosure.

The present disclosure has been described in accordance with embodiments. However, the present disclosure is not limited to this embodiment and structure. This disclosure also encompasses various modifications and variations within the scope of equivalents. Furthermore, various combination and formation, and other combination and formation including one, more than one or less than one element may be made in the present disclosure.

1. A shift range control device that controls a shift range switching system including an actuator, an output shaft driven by the actuator, and a shift range switching mechanism having a driven member in which a plurality of valley portions and mountain portions separating the valley portions are formed and that rotates together with the output shaft, an engagement member which moves the valley portion by driving the actuator, and an urging member which urges the engagement member in a direction of fitting into the valley portion, the shift range control device comprising:
a target setting unit configured to set a target shift range;
a drive control unit configured to control the drive of the actuator so that the engagement member fits into a target valley portion, which is a valley portion corresponding to the target shift range; and
an abnormality monitoring unit configured to monitor an abnormality,
wherein
when a stagnation abnormality is determined in which the engagement member does not reach the target valley portion and stagnates, the drive control unit controls the drive of the actuator so that the engagement member fits into the valley portion on a side where the engagement member is returned from a stagnant position.

2. The shift range control device according to claim 1, wherein the target setting unit resets the target shift range according to at least one of the stagnant position and the shift range before a start of range switching when the stagnation abnormality is determined.

3. The shift range control device according to claim 2, wherein
when the stagnation abnormality is confirmed, the target setting unit resets the range corresponding to the valley portion closest to a return side from the stagnant position to the target shift range.

4. The shift range control device according to claim 2, wherein
when the stagnation abnormality is confirmed and the valley portion corresponding to a non-driving range exists on the side where the engagement member is returned from the stagnant position,
the target setting unit resets the non-driving range to the target shift range.

5. The shift range control device according to claim 4, wherein
when the stagnation abnormality is confirmed and the shift range before the start of range switching is a parking range, the non-driving range is set to the parking range, and
the target setting unit resets the parking range to the target shift range.

6. The shift range control device according to claim 4, wherein
when the stagnation abnormality is confirmed and a neutral range is passed from the start of range switching to the stagnant position, the non-driving range is set to the neutral range, and
the target setting unit resets the neutral range to the target shift range.

7. The shift range control device according to claim 1, further comprising,
a notification unit configured to notify an user that an abnormality is occurred when a driver request shift range and the shift range after the switching is completed are different, wherein
the notification unit has different warning contents to be notified to the user according to the shift range before a start of switching and the shift range after the switching is completed.

8. A shift range control method for controlling a shift range switching system including an actuator, an output shaft driven by the actuator, and a shift range switching mechanism having a driven member in which a plurality of valley portions and mountain portions separating the valley portions are formed and that rotates together with the output shaft, an engagement member which moves the valley portion by driving the actuator, and an urging member which urges the engagement member in a direction of fitting into the valley portion, the method comprising:
(a) setting a target shift range;
(b) controlling the drive of the actuator so that the engagement member fits into a target valley portion, which is a valley portion corresponding to the target shift range;
(c) monitoring a stagnation abnormality in which the engagement member does not reach the target valley portion and stagnates; and
(d) when the stagnation abnormality is confirmed, controlling the drive of the actuator so that the engagement member fits into the valley portion on a side where the engagement member is returned from a stagnant position.

9. The shift range control method according to claim 8, further comprising,
(e) resetting the target shift range according to at least one of the stagnant position and the shift range before a start of range switching when the stagnation abnormality is determined.

10. A shift range device, comprising:
a shift range switching system, and
a shift range control device configured to control the shift range switching system, wherein
the shift range switching system includes
an actuator,
an output shaft driven by the actuator, and
a shift range switching mechanism having a driven member in which a plurality of valley portions and mountain portions separating the valley portions are formed and that rotates together with the output shaft, an engagement member which moves the valley portion by driving the actuator, and an urging member which urges the engagement member in a direction of fitting into the valley portion, and
the shift range control device includes
a computer including a processor and a memory that stores instructions configured to, when executed by the processor, cause the processor to
set a target shift range,
control the drive of the actuator so that the engagement member fits into a target valley portion, which is a valley portion corresponding to the target shift range,
monitor a stagnation abnormality in which the engagement member does not reach the target valley portion and stagnates, and
when the stagnation abnormality is confirmed, control the drive of the actuator so that the engagement member fits into the valley portion on a side where the engagement member is returned from a stagnant position.

11. The shift range device according to claim 10, wherein
the computer causes the processor to reset the target shift range according to at least one of the stagnant position and the shift range before a start of range switching when the stagnation abnormality is determined.
